(19) United States
(12) Patent Application Publication
(10) Pub. No.: US 2017/0370126 A1
(43) Pub. Date: Dec. 28, 2017

(54) High-strength Security Lock Cylinder

(71) Applicants: Rui Zhang, Beijing (CN); Qiang Zhang, Beijing (CN)

(72) Inventors: Rui Zhang, Beijing (CN); Qiang Zhang, Beijing (CN)

(21) Appl. No.: 15/539,982

(22) PCT Filed: Feb. 17, 2016
(86) PCT No.: PCT/CN2016/073939

§ 371 Date: Jun. 26, 2017

(30) Foreign Application Priority Data
Mar. 16, 2015 (CN) 201510113668.1

(51) Int. Cl. E05B 47/00; E05B 15/16; E05B 9/04; E05B 29/00; E05B 49/00

(52) U.S. Cl. CPC E05B 47/0001; E05B 29/00; E05B 49/00; E05B 9/04; E05B 15/1614; E05B 2047/0084

(57) ABSTRACT

This invention discloses a high strength security lock cylinder. The lock cylinder includes a front lock housing, a front lock plug, a rear lock housing, a rear lock plug, a horizontal bar, and a lock cam. The front and rear lock plugs are connected with the lock cam and can drive the lock cam to rotate. An electronic locking mechanism is placed inside the front lock plug. The rear lock plug is connected with an axel, which is connected with a knob that contains a digital control board and an electrical power source. A signal transmission channel is formed along the horizontal bar for transmitting signals between the electronic locking mechanism and the digital control board. The lock cylinder is flexible, strong, and resistant to drilling and lock picking and it can be digitally controlled. This reduces the security risks caused by misplacement or unauthorized use of keys.

### FIELD OF INVENTION

This invention generally relates to a type of lock structure. More specifically, this invention relates to a type of lock cylinder.

### BACKGROUND OF THE INVENTION

Wafer lock cylinders and digital lock cylinders are the two most common types of lock cylinder constructions currently in use. Wafer locks possess a flexible structure. They are generally very strong and can resist drilling and lock picking. In contrast, digital locks, due to the fact that they utilize digital control technology, allow for a unique key management method, which allows for instantaneous change of the authorized key. This reduces security risks arising from the misplacement or unauthorized use of keys. It is desirable to combine the two lock cylinder mechanisms to provide a better solution for consumers.

### SUMMARY OF THE INVENTION

In one embodiment of the present invention, the lock cylinder has a front lock housing and a rear lock housing which are placed on the two opposite ends of a lock cam. Within the front lock housing is a front lock plug, which can rotate within the front lock housing. Within the rear lock housing is a rear lock plug, which can rotate within the rear lock housing. A horizontal bar is attached to the front lock housing on one end and the rear lock housing on the other. The front and rear lock plugs are connected to opposite ends of the lock cam and drive the rotational movement of the lock cam. A keyhole for insertion of a key is formed in the front lock plug. The front lock plug also contains wafers that match the key. Additionally, an electronic locking mechanism is contained in the front lock housing and front lock plug. The back of the rear lock plug is fixed to an axel. This axel is connected to a knob. A digital control board and electrical power source are integrated inside the knob. A signal transmission channel is placed along the horizontal bar for transmitting signals between the electronic locking mechanism and the digital control board, forming a complete control system.

In another embodiment of the present invention, a groove that matches the shape of the horizontal bar is formed into the front lock housing and rear lock housing, respectively. The two ends of the horizontal bar are inserted into the groove. The horizontal bar and the groove have matching screw holes that allow for securing the horizontal bar to the front and rear lock housings.

In yet another embodiment of the present invention, the front lock housing, rear lock housing, and horizontal bar are made of stainless steel.

In yet another embodiment of the present invention, the side of the rear lock housing facing away from the lock cam has a fixed cover.

This invention comprises a number of components, among which the front lock housing, the rear lock housing, and the horizontal bar may be made of stainless steel. The lock cylinder is flexible, strong, and resistant to drilling and lock picking. One side of the lock cylinder does not contain wafers but rather a knob that contains a digital control board and electrical power source. The advantage of this design is that it allows the lock cylinder to be digitally controlled. This solves the security risks caused by misplacement or unauthorized use of keys. By preventing unauthorized entry, the lock cylinder results in a substantial improvement in security.

### BRIEF DESCRIPTION OF THE FIGURES

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying Figures. Additionally, the same reference numbers are used across all figures.

FIG. 1 is an overall structural diagram illustrating a lock cylinder, according to some embodiments of the present invention.

FIG. 2 is a cross-section view of a lock cylinder, according to some embodiments of the present invention.

The reference numbers identify the following components: front lock housing 1, front lock plug 2, rear lock housing 3, rear lock plug 4, horizontal bar 5, lock cam 6, keyhole 7, wafer(s) 8, axel 9, rear fixed cover 10, knob 11, groove 12, and screw holes 13.

### DETAILED DESCRIPTION

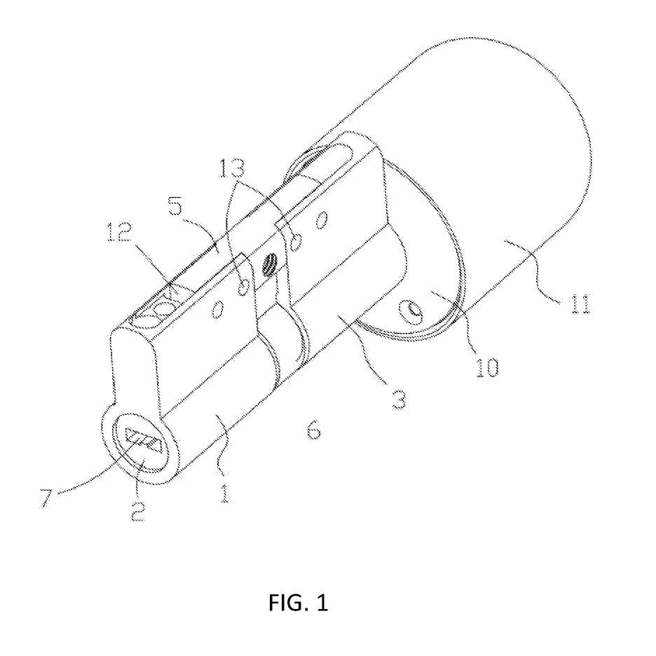

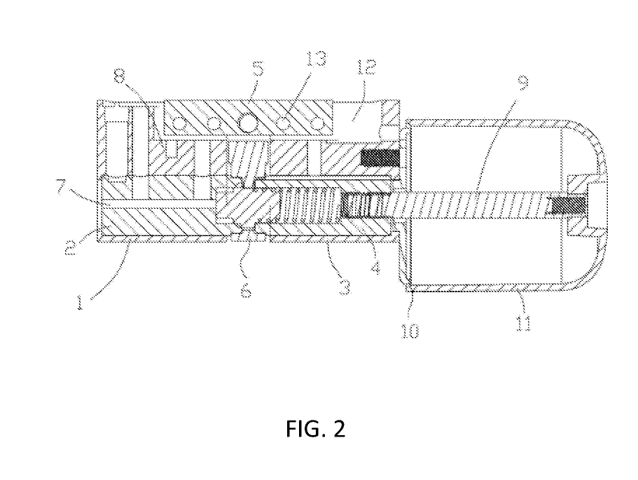

FIG. 1 is an overall structural diagram illustrating a lock cylinder. In one embodiment, as seen in FIGS. 1 and 2, the invented lock cylinder mainly comprises: a front lock housing 1, a front lock plug 2, a rear lock housing 3, a rear lock plug 4, a horizontal bar 5, a lock cam 6, wafer(s) 8, an axel 9, as well as a knob 11.

The front lock housing 1 and rear lock housing 3 are placed on the two opposite sides of the lock cam 6. The front lock plug 2 is installed within the front lock housing 1 and can rotate within the front lock housing 1. The rear lock plug 4 is installed within the rear lock housing 3 and can rotate within the rear lock housing 3. A horizontal bar 5 is attached to the front lock housing 1 on one end and to the rear lock housing 3 on the other. The front lock plug 2 and rear lock plug 4 are connected to the opposite ends of a lock cam 6 and drive the rotational movement of the lock cam. A keyhole 7 for insertion of a key is formed in the front lock plug. The front lock plug also contains wafers 8 that match the key. Additionally, an electronic locking mechanism is contained in the front lock housing 1 and front lock plug 2. The electronic locking mechanism may be implemented with an electric solenoid having a stainless steel bolt inside. When powered with electric current, the electric solenoid generates enough magnetic force to move the bolt to lock or unlock a door. The back of the rear lock plug 4 is fixed to an axel 9. This axel 9 is connected to a knob 11. A digital control board and electrical power source are integrated inside the knob 11. A signal transmission channel is placed along the bar for transmitting signals between the electronic locking mechanism and the digital control board, forming a complete control system. For example, a key may have a 64-bit crypto IC (integrated circuit). When the key is inserted into the lock cylinder, the digital control board can read the code stored in the crypto IC. The digital control board compares the code with a stored authorization code. If the two codes do not match, the digital control board sends a signal to the electronic locking mechanism through the signal transmission channel, triggering the electronic locking mechanism to lock down the door.

It can be seen from the above structure that the invention is different from traditional wafer lock cylinders. The invention changes the original double sided key opening mechanism into a single sided key opening mechanism. The rear lock plug is not unlocked with a key. Rather, it is unlocked by a rotating axel. The rear lock plug is installed on the interior side of a room. To unlock a door from the interior side, it is only required to turn the axel to rotate the rear lock plug. A rear fixed cover 10 and a knob 11 are also installed in this portion. The rear fixed cover 10 is used for the purposes of installation and fixation. As shown in FIG. 2, the rear fixed cover 10 is affixed to the side of the rear lock housing 3 facing away from the lock cam 6. The invention places a digital control board and an electrical power source inside the knob 11. This does not require a substantial change to the structure of the lock cylinder. As such, the lock cylinder can be made more integrated and compact. Additionally, through a signal transmission channel formed along the horizontal bar 5, signals may be transmitted to the electronic locking mechanism in the front lock housing and front lock plug, achieving the function of complete digital control.

The entire structure of the invention comprises a number of modules assembled together. These modules include (1) the front lock module, which includes the front lock housing and the front lock plug, (2) the rear lock module, which includes the rear lock housing and the rear lock plug, (3) the horizontal bar, and (4) the lock cam. The horizontal bar connects the front and the rear modules of the structure. To facilitate the connection and fixation, the front lock housing 1 and rear lock housing 3 each have a groove 12 that matches the shape of the horizontal bar 5. The two ends of the horizontal bar 5 are inserted into the groove 12. The horizontal bar and the groove have matching screw holes 13 that allow for securing the horizontal bar to the front and rear lock housings. When assembling, all that is required is screwing screws into the screw holes until the horizontal bar and the housings are secured together. The front lock housing, rear lock housing, and horizontal bar are normally manufactured from stainless steel to improve the strength of the lock cylinder, preventing lock drilling and lock picking.

Due to its module-based structure, the invention can be configured to suit the thickness of a door. The horizontal bar may have a fixed size and dimension, while the front lock module, including the front lock housing and the front lock plug, and the rear lock module, including the rear lock housing and the rear lock plug, may be of different sizes. For example, the front and rear lock modules may be designed to have various lengths, such as 35 mm, 40 mm, 45 mm, 50 mm, 55 mm, 60 mm, or 65 mm. In combination, they can produce 49 different lock cylinders with a length varying in the range of 70 mm-130 mm, basically covering all the various thicknesses of doors on the market.

The invention's digital control board and electrical power source are used to implement the lock cylinder's digital control mechanism, which provides a great improvement from traditional lock cylinder designs in terms of preventing the lock from being compromised. In addition, the key management function allows admin users to instantly authorize or unauthorized certain keys, improving the safety and economic measures of the lock cylinder.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A high strength security lock cylinder comprising:
a front lock housing;
a front lock plug placed and configured to rotate within the front lock housing, wherein the front lock plug has a keyhole for receiving a key and contains a plurality of wafers that match the key;
a rear lock housing;
a rear lock plug placed and configured to rotate within the rear lock housing;
a horizontal bar having two ends, wherein the horizontal bar connects with the front lock housing at one end and with the rear lock housing at the other end;
a lock cam placed between the front lock housing and the rear lock housings and connected with the front lock plug and the rear lock plug such that any rotation of the front lock plug or the rear lock plug would drive the lock cam to rotate;
an electronic locking mechanism contained inside the front lock plug;
an axel fixed to the rear lock plug;
a knob connected with the axel, wherein the knob contains a digital control board and a power source; and
a signal transmission channel formed along the horizontal bar for transmitting information between the electronic locking mechanism and the digital control board.

2. The high strength security lock cylinder of claim 1, wherein the front lock housing has a groove that matches one end of the horizontal bar and the rear lock housing has a groove that matches the other end of the horizontal bar, wherein the horizontal bar, the groove of the front lock housing, and the groove of the rear lock housing have matching screw holes for securing the horizontal bar to the front lock housing and the rear lock housing.

3. The high strength security lock cylinder of claim 1, wherein the front lock housing, the rear lock housing, and the horizontal bar are made of stainless steel.

4. The high strength security lock cylinder of claim 1 further comprising a rear fixed cover fixed to the rear lock housing.
